(19) United States
(12) Patent Application Publication
(10) Pub. No.: US 2010/0238345 A1
(43) Pub. Date: Sep. 23, 2010

(54) Adjustable Control for an Inertial Stabilizer

(75) Inventors: Richard G. Greb, Raleigh, NC (US); Adrian R. Sanderson, Raleigh, NC (US); Patrick L. Thiel, Raleigh, NC (US)

Correspondence Address: COATS & BENNETT, PLLC, 1400 Crescent Green, Suite 300, Cary, NC, 27518, US

(73) Assignee: Camera Motion Research, LLC, Raleigh, NC (US)

(21) Appl. No.: 12/414,736

(22) Filed: Mar. 31, 2009

Related U.S. Application Data
(60) Provisional application No. 61/161,982, filed on Mar. 20, 2009.

(51) Int. Cl. H04N 5/225

(52) U.S. Cl. 348/373; 348/E05.024

(57) ABSTRACT

A handle assembly connects to a support assembly of an inertial stabilizer. The handle assembly comprises a handle grip, a multi-axis joint that allows the handle grip to move relative to the support assembly about two or more axes of rotation, and an adjustable friction control that allows a user to adjust or vary an amount of friction that is applied to the axes of rotation. Allowing the user to increase and decrease the amount of friction applied to the axes of rotation in a controlled manner allows the user to effectively isolate the inertial stabilizer from the undesirable effects of user motion.

### RELATED APPLICATIONS

This application claims priority under 35 U.S.C. § 119(e) from U.S. Provisional Patent Application Ser. No. 61/161,982, which was filed on Mar. 20, 2009. The '982 application, which is entitled “Adjustable Control for An Inertial Stabilizer,” is incorporated herein by reference in its entirety.

### TECHNICAL FIELD

The present invention relates generally to stabilizers for optical equipment, and particularly to adjustable user controls for stabilizers that isolate the optical equipment from the undesirable effects of user motion.

### BACKGROUND

Inertial camera stabilizer devices for video cameras and other optical equipment have been in use for many years. Some stabilizers, for example, are used for hand-held video cameras while others are used for large cameras that are supported by a body vest worn by the operator. Generally, inertial camera stabilizers allow an operator the freedom to perform a wide array of movements, such as walking, running, climbing steps, and other movements, while isolating the body of a camera or other optical equipment from the unwanted effects caused by these movements. Such isolation can eliminate or greatly reduce the undesirable effects in the roll, tilt, and pan directions, thereby providing a smooth video or film recording for the operator.

One type of stabilizer is a passive inertial camera stabilizer. Structurally, most passive stabilizers comprise a camera mount, a counterbalancing weight system, and a support structure that connects the counterbalancing weight system to the camera mount. A pivot point between the camera mount and the counterbalancing system is near, but not exactly at, the center of gravity of the support structure. Typically, the center of gravity of a stabilizer is between the pivot point and the counterbalancing system thereby making the stabilizer slightly “bottom heavy.” Thus, even when a camera wanders off-axis, the slightly bottom heavy nature of the stabilizer causes it to automatically return the camera to a steady state (i.e., upright) position such that the camera is maintained substantially level with the horizon. Such stabilizers require little or no operator intervention to maintain the camera parallel to the horizon, which is the most common shot framing position.

Some passive stabilizers implement the pivot point as a multi-axis gimbal. As those skilled in the art understand, a multi-axis gimbal is a pivoted support that permits an object to rotate freely about three different axes of rotation (e.g., x-axis, y-axis, and z-axis). Other passive inertial stabilizers employ a plurality of single-axis gimbals, each of which pivots about a different axis of rotation. Both types of gimbals allow the stabilizer (and thus, the mounted camera) to pivot about the axes of rotation freely, thereby effectively isolating the camera from the motions of the operator in the roll, tilt, and pan directions.

The gimbals used on conventional passive inertial camera stabilizers are near-frictionless mechanisms. Typically, manufacturers use precision ball bearings in all axes to achieve near-frictionless movement in all three axes. The near-frictionless mechanisms help to achieve isolation between the operator movement and the camera. However, with a bottom heavy balance position and low friction or near frictionless gimbals, any acceleration or deceleration, including movement in an arc, could produce unwanted motion. For example, when the operator moves in a direction (e.g., forward), the camera, which mounts to the stabilizer opposite the bottom-heavy portion of the stabilizer, will tend to move or tilt in the same direction as the operator (e.g., forward). The slightly bottom-heavy portion of the stabilizer, however, will lag behind the camera. Although the camera will slowly return to its original position, such movement may cause the camera to rock undesirably. Other conditions and factors, such as aerodynamic drag, wind while filming outdoors, or the imperfect design and/or construction of the stabilizer, can also cause the camera to experience unwanted reaction torque induced motion. Both handheld and body vest mounted inertial stabilizers require significant operator skill levels to reduce such movement.

### SUMMARY

The present invention a user-operated, adjustable control that permits an operator of an inertial stabilizer to control an amount of friction that is applied one or more axes of rotation. In one embodiment, the inertial stabilizer comprises a support assembly having a stage and a counterbalance. The stage supports an optical recording device, such as a video camera, for example. The counterbalance maintains an appropriate balance for the stabilizer by compensating for optical devices that are too heavy or too light. The inertial stabilizer also includes a handle assembly connected to the support assembly. The handle assembly comprises a handle grip, a multi-axis joint connecting the handle grip to the support assembly such that the handle grip and the support assembly move relative to each other in at least two axes of rotation, and an adjustable friction control to allow the user control an amount of friction on one or more axes of rotation. According to the present invention, the operator can operate a control knob on the adjustable friction control, for example, to increase and decrease the amount of friction that is applied to one or more of a roll, a tilt, and a pan axis of rotation.

The present invention may be used with different types of inertial stabilizers having different multi-axis joints to allow the operator to control the amount of friction applied to the rotational axes of the inertial stabilizer. In one embodiment, for example, the multi-axis joint connects the handle grip to the support assembly such that the handle grip is substantially co-axial with a pan axis of rotation of the inertial stabilizer. For these types of inertial stabilizers, there may be one or more adjustable friction controls to control friction. For example, one or more adjustable friction controls may be connected to the multi-axis joint to allow the operator to control friction on the roll and tilt axes. Another adjustable friction control may be included in the handle grip to allow the operator to control the amount of friction applied to the pan axis. Controlling the amount of friction on the pan axis will allow the operator to control the panning motion of the inertial stabilizer, or prevent the stabilizer from panning altogether.

In another embodiment, the multi-axis joint connects the handle grip to the support assembly such that the handle grip is offset from the pan axis of rotation of the inertial stabilizer. A plurality of adjustable friction controls may be used with these types of inertial stabilizers to control friction. For example, one or more adjustable friction controls may be connected to the multi-axis joint to allow the operator to control friction on the roll axis, while another adjustable friction control may be used to control friction on the tilt axis. Another adjustable friction control may be used to control the amount of friction applied to the pan axis.

### BRIEF DESCRIPTION OF THE DRAWINGS

FIG. 1 is a perspective view illustrating a passive inertial stabilizer configured according to one embodiment of the present invention.

FIGS. 2A-2D are perspective views illustrating a handle assembly for an inertial stabilizer having an adjustable friction control according to one embodiment of the present invention.

FIG. 3 is a flow diagram illustrating a method by which an adjustable friction control may be used to vary the amount of friction applied to a multi-axis pivot assembly according to one embodiment of the present invention.

FIG. 4 is a perspective view illustrating an adjustable friction control according to another embodiment of the present invention.

FIG. 5 is a perspective view of a handle assembly for an inertial stabilizer having an adjustable friction control according to another embodiment of the present invention.

FIG. 6 is a perspective view of a handle assembly for an inertial stabilizer having an adjustable friction control according to another embodiment of the present invention.

FIG. 7 is a sectional view of a handle assembly illustrating some of the component parts of the adjustable friction control.

FIG. 8 is a perspective view illustrating an adjustable friction control configured according to another embodiment of the present invention.

FIGS. 9A-9B are sectional views illustrating some of the component parts of an adjustable friction control configured according to the embodiment of FIG. 8.

### DETAILED DESCRIPTION

Users typically move around while filming video using optical recording devices, such as video cameras. To isolate the camera from the effects of undesirable user motion, some users mount the cameras to passive inertial stabilizers. Conventional inertial stabilizers employ a low-friction gimbal assembly to isolate the stabilizer, and thus, the camera, from the user's movements. However, the same low friction characteristics that allow a gimbal assembly to efficiently isolate the stabilizer from the user motion may also cause the stabilizer to undesirably experience the effects of one or more reaction torque forces. Such forces often disturb the camera's stability and/or orientation by causing unwanted rotational motion for the camera in a roll, tilt and/or panning direction. This interferes with the camera's ability to produce smooth video.

The present invention, therefore, provides a passive inertial camera stabilizer having an adjustable friction control to allow an operator to vary the amount of friction that is applied to a multi-axis pivot assembly on one or more of its rotational axes. Intentionally adding a controlled amount of friction to the multi-axis pivot assembly noticeably reduces the undesirable effects of the reaction torque forces on the stabilizer. The added friction will affect the coupling between the operator and the stabilizer. Therefore, the stabilizer will likely experience some effects of user motion. However, since the operator can control the amount of friction applied to the multi-axis pivot assembly with the present invention, such effects are slight and largely unnoticeable. The overall effect of the controlled friction reduces the effects caused by the reaction torque forces, and the skill level required by an operator to achieve a given level of stabilizer performance.

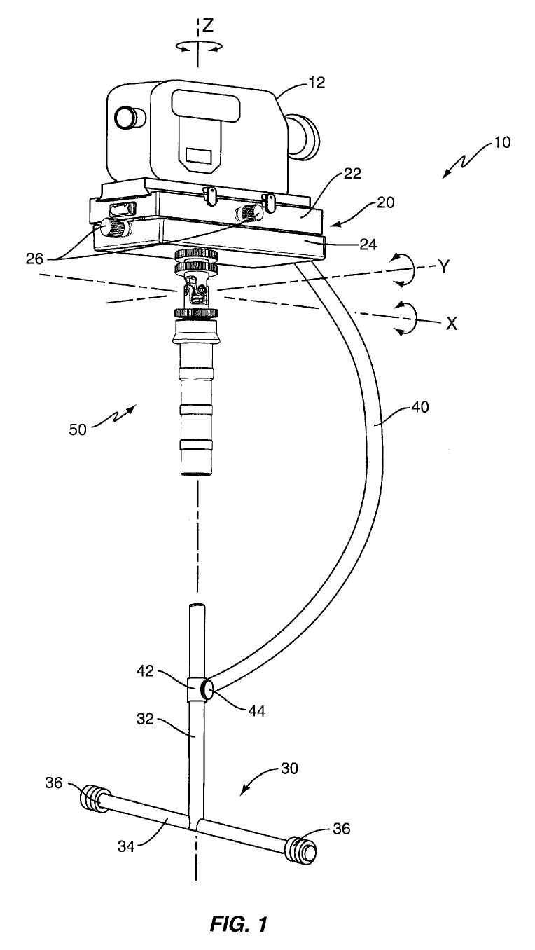

FIG. 1 is a perspective view illustrating a passive inertial camera stabilizer 10 suitable for use with one embodiment of the present invention. The stabilizer, generally indicated by the number 10, is a hand-held device upon which a video camera 12 may be releasably mounted. The stabilizer 10 is a support assembly comprising a stage assembly 20, a counterbalance assembly 30, a rigid support member, such as strut 40 that interconnects the stage assembly 20 to the counterbalance assembly 30, and a handle assembly 50.

The stage assembly 20 comprises a substantially flat platform 22 and a base compartment 24. The platform 22 includes hardware, such as clamps and the like, to releasably mount the camera 12 to its top surface, and is movable independently of the base compartment 24 and the other components of stabilizer 10. Any mechanism known in the art may be used to move the platform 22; however in one embodiment, a mechanical linkage (not shown) housed within the interior of base compartment 24 movably connects the platform 22 to one or more user control knobs 26 disposed on a sidewall of the base compartment 24. The control knobs 26 connect to the linkage and operate independently to move the platform 22 in a plane that is substantially parallel to the x and y-axes. The ability to adjust the position of the platform 22 in this “x-y plane” independently of the other components of the stabilizer 10 allows the operator to balance the stabilizer 10.

The counterbalance assembly 30 compensates for cameras 12 that are too heavy or too light to maintain a proper balance. In this embodiment, the counterbalance system 30 comprises first and second rigid members 32, 34 coupled together to form an inverted “T.” One or more masses 36 of varying weights may be releasably attached to each end of the second rigid member 34. The masses 36 function to counterbalance the weight of the camera 12 and the stage assembly 20 so that the operator can obtain a proper balance for the stabilizer 10. By way of example, the operator may add one or more masses 36 to each end of the second rigid member 34 to counterbalance cameras 14 that are heavy. For lighter cameras 12, however, those additional masses 36 may be removed. The masses 36 may be formed such that they interlock with each other when multiple masses are used.

The strut 40, which in this embodiment comprises an arcuate tubular member, suspends the counterbalance assembly 30 below the stage assembly 20. As seen in FIG. 1, the strut 40 fixedly attaches to the stage assembly 20 at one end. The opposite end of strut 40 includes a coupling 42 that is sized to receive and slidably retain the first rigid member 32. When connected to the coupling 42, the first rigid member 32 is substantially aligned along its longitudinal axis with a pan axis (i.e., the z-axis) of stabilizer 10. An operator may loosen a mechanical fastener 44, for example, on coupling 42, and slide the first rigid member 32 through the coupling 42 to raise or lower the counterbalance system 30. Once the operator has moved the counterbalance system 30 to a desired position, the operator may tighten the mechanical fastener 44 to retain the first rigid member 32 in place. When properly balanced and positioned, the counterbalance assembly 30 maintains the stabilizer 10 in a relatively neutral state (i.e., in an upright position) by making the stabilizer 10 slightly “bottom heavy.” Thus, even if the stabilizer 10 moves off axis, the stabilizer 10 returns to an upright position automatically such that the camera 12 is maintained substantially level with the horizon.

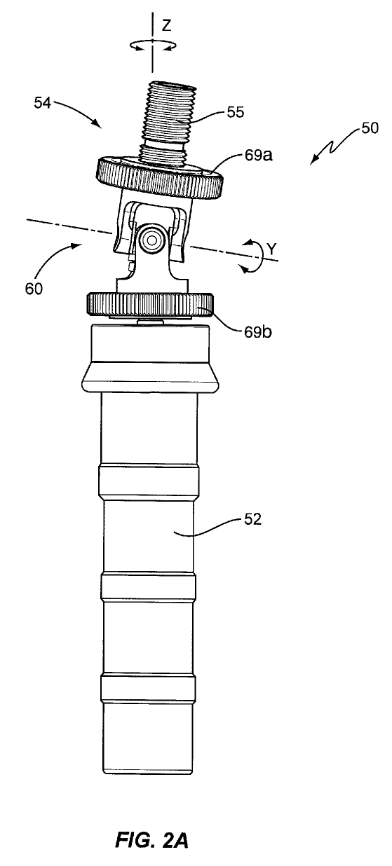

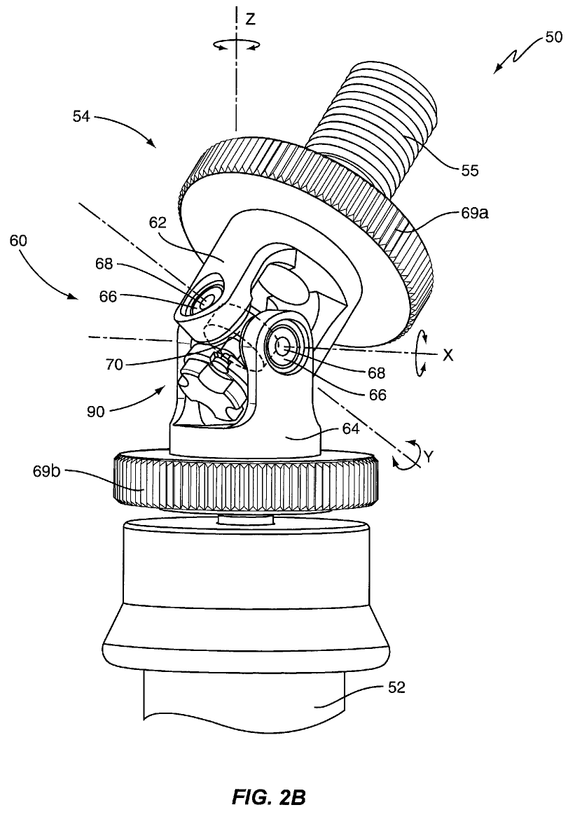

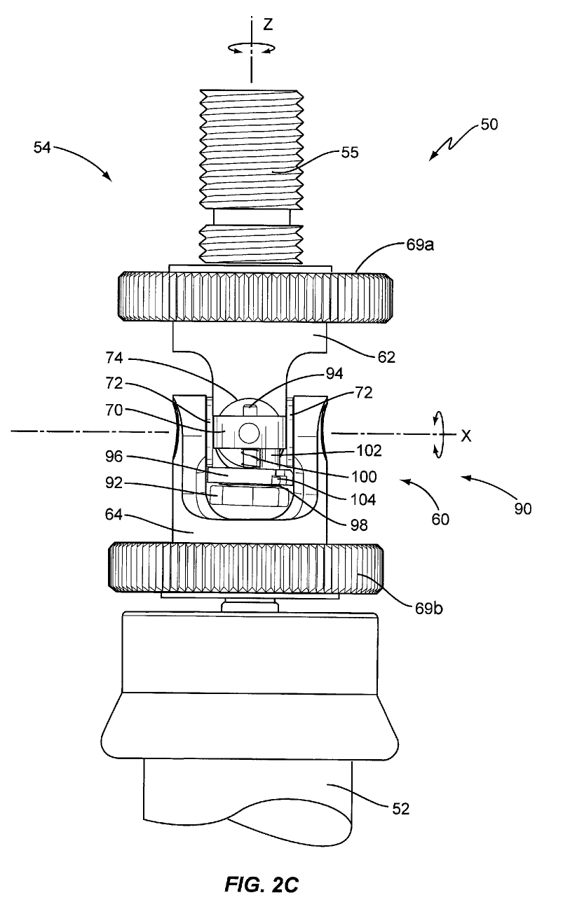

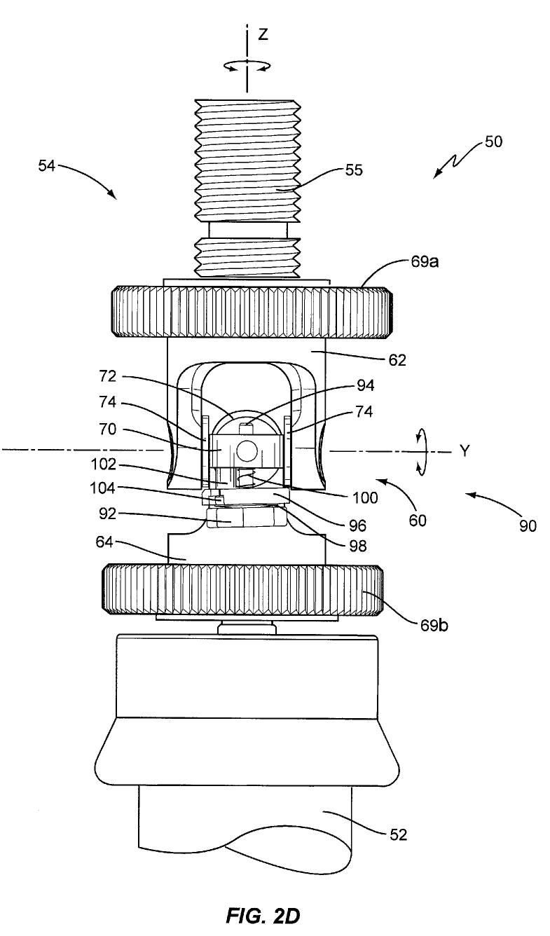

FIGS. 2A-2D illustrate the handle assembly 50 in greater detail. As seen in FIG. 2A, the handle assembly 50 comprises a handle grip 52, a coupler 54, and a multi-axis pivot assembly 60. In some embodiments of the present invention, the handle assembly 50 also includes an adjustment mechanism (not shown) to allow the operator to adjust a distance between the multi-axis pivot assembly 60 and the base assembly 20 for proper balance in the z-axis.

The handle grip 52 comprises a substantially cylindrical member sized for a human hand. The coupler 54 comprises a threaded shaft 55 that, in this embodiment, is integrally formed with an upper control ring 69a. The threaded shaft 55 threadingly attaches the handle assembly 50 to the base compartment 24 of the stage assembly 20. The upper control ring 69a allows the operator to rotate the stabilizer 10 about its z-axis or control roll or tilt about the x and y axes. The multi-axis pivot assembly 60 pivotably connects the handle grip 52 to the coupler 54 such that the handle grip 52 and the coupler 54 pivot freely about a least two axes of rotation relative to one another. In this embodiment, for example, the multi-axis pivot assembly 60 comprises a two-axis gimbal disposed between the handle grip 52 and the coupler 54; however, other two-axis mechanisms are equally as suitable.

As seen in FIG. 2B, the multi-axis pivot assembly 60 defines an x-axis (i.e., the roll axis) and a y-axis (i.e., the tilt axis), and pivots about those axes to provide the handle grip 52 and the stabilizer 10 with multiple degrees of freedom. However, the multi-axis pivot assembly 60 remains in a fixed position relative to the other components of stabilizer 10. The x and y-axes are orthogonal to each other, and intersect at a common intersection point located within the multi-axis pivot assembly 60. Similarly, the z-axis is orthogonal to both the x and the y-axes, and also intersects the x and y-axes at the common intersection point.

As previously stated, most, if not all conventional inertial stabilizers emphasize the need for a near-frictionless gimbal mechanism as a pivot support. The reason for such near-frictionless mechanisms is that it provides suitable isolation between a human operator and a camera mounted to a stabilizer. Although these conventional near-frictionless mechanisms help to achieve such isolation, they also usually introduce unwanted reaction torques whenever an operator accelerates or decelerates. Thus, conventional low-friction or near-frictionless pivot support mechanisms tend to produce unwanted reaction motions in an inertial stabilizer responsive to any acceleration or deceleration, including movement in an arc.

The present invention improves on such conventional camera inertial stabilizers by implementing an adjustable control mechanism to allow the operator to control an amount of friction on one or more of the roll, tilt, and/or pan axes. In one embodiment, a user adjustable friction control 90 provided at the multi-axis pivot assembly 60 allows the operator to intentionally add and/or remove the amount of friction that is applied to the roll and/or tilt axes of the multi-axis pivot assembly 60. In another embodiment, described in more detail later, a user adjustable friction control provided with the handle assembly 50 allows the operator to intentionally add and/or remove the amount of friction that is applied to the pan axis. Allowing the operator to vary the amount of friction intentionally applied at the one or more of these axes reduces the undesirable effects of reaction torque forces experienced by the stabilizer 10 without grossly affecting the ability of the stabilizer 10 to isolate the camera 12 from user movement.

FIGS. 2B-2D illustrate the multi-axis pivot assembly 60 and the adjustable user friction control 90 in more detail. In FIGS. 2C-2D, a portion of the multi-axis pivot assembly 60 has been cut-away to better illustrate the components of the multi-axis pivot assembly 60, and the adjustable friction control 90 in more detail.

Particularly, these figures illustrate the multi-axis pivot assembly 60 as comprising a 2-axis gimbal that pivotably connects the handle 52 to the coupler 54. The multi-axis pivot assembly 60 provides four degrees of freedom—two in each of the roll and tilt axes—and employs low friction or near-frictionless bearings to isolate the camera 12 mounted to the base assembly 20 from the undesirable effects of user movement. The adjustable friction control 90 is integrated into the multi-axis pivot assembly 60 and allows the operator to increase or decrease the amount of friction applied to selected components of the multi-axis pivot assembly 60.

The multi-axis pivot assembly 60 comprises a pair of U-shaped yokes 62, 64. A first yoke 62 is fixedly attached to the upper control ring 69a while the opposing yoke 64 is fixedly attached to a lower control ring 69b on the handle grip 52. In this embodiment, each yoke 62, 64 is integrally formed with its respective upper and lower control ring 69 as a unitary piece. However, those skilled in the art will appreciate that the present invention is not limited to this structure. One or both of the yokes 62, 64, may be formed as separate pieces and then fixedly attached to their respective control rings using mechanical fasteners or by welding the pieces together, for example.

A center block 70 pivotably connects the yokes 62, 64 together such that the yokes 62, 64 pivot freely about the center block 70. Particularly, as best seen in FIG. 2B, each yoke 62, 64 has a pair of embedded, low-friction or near-frictionless yoke bearings 66 that receive corresponding connecting pins 68. The connecting pins 68, which extend into the center block 70, rotate freely within the yoke bearings 66. This allows the yokes 62, 64 to pivot freely about the center block 70.

Each yoke 62, 64 also includes at least one disc-shaped flange 72, 74, respectively, through which the connecting pins 68 pass. As seen in FIGS. 2C-2D, each flange 72, 74 is disposed between an interior surface of its respective yoke 62, 64 and the center block 70. In this embodiment, there are four (4) disc-shaped flanges 72, 74—two for each axis; however, only one flange 72, 74 per axis is needed. In one embodiment of the present invention, the operator can control the amount of friction that is placed on the multi-axis pivot assembly 60 by using the adjustable friction control 90 to increase and decrease the amount of force applied to one or more of the flanges 72, 74.

The adjustable friction control 90 comprises a rotatable control knob 92, a threaded center pin 94, a friction disc 96, a pair of biasing members 98, 100, and a post 102. The friction disc 96 is supported between the yokes 62, 64 in part by the center pin 94 that threads into an opening or hole in the center block 70. As described in more detail later, the friction disk 96 is configured to contact one or more of the flanges 72, 74 with a varying amount of force that is controlled by the operator via the rotatable control knob 92. In some embodiments of the present invention, the friction disk 96 may be formed with one or more indentations on its surface that receive corresponding projecting members formed on flanges 72, 74. When mated, the indentations and the projecting members help to prevent rotation of the friction disk 96.

The post 102 comprises a rigid member and is positioned on the friction disk 96 such that it bisects the points at which the friction disk 96 contacts the flanges 72, 74. One end of the post 102 is retained in a notch 104 formed in the friction disc 96, while the opposing end of post 102 is retained in a hole formed in the center block 70. The post 102 functions to prevent the friction disk 96 from rotating, and serves as a support point that distributes the load between the post 102 and the points at which the flanges 72, 74, contact the flanges. More particularly, the post 102 prevents the friction disk 96 from collapsing onto the center block 70 when the operator increases friction.

The control knob 92 is attached to the center pin 94, which extends through the friction disk 96 and through the central block 70. A biasing member 98, 100 is positioned on either side of the friction disk 92. Specifically, a first biasing member 98 comprising a wave spring or a cupped spring, for example, is disposed between the control knob 92 and the friction disk 96. The second biasing member 100, which may comprise a coil spring, for example, is disposed between the friction disk 96 and the central block 70. The springs function to provide the operator with a way to judge the amount of friction that is being applied to the multi-axis pivot assembly 60.

Particularly, when the operator rotates the control knob 92 in a first direction (e.g., clockwise), the biasing members 98, 100 compress to increasingly resist the operator's efforts at turning the control knob 92. The increasing resistance to the operator's efforts translates to increasing the amount of friction that is applied to one or more axes of the multi-axis pivot assembly 60. Conversely, as the operator turns the control knob 62 in the opposite direction (e.g., counter-clockwise), the biasing members 98, 100 decompress making it easier for the operator to turn the control knob 92 in that direction. This decreasing resistance to the operator's efforts at turning the control knob 92 translates to decreasing the amount of friction that is applied to one or more axes of the multi-axis pivot assembly 60. Thus, the biasing members 98, 100 function to provide the operator with a “tactile feedback” mechanism to let the operator know whether the friction being applied to the one or more axes of the multi-axes pivot assembly 60 is being increased or decreased.

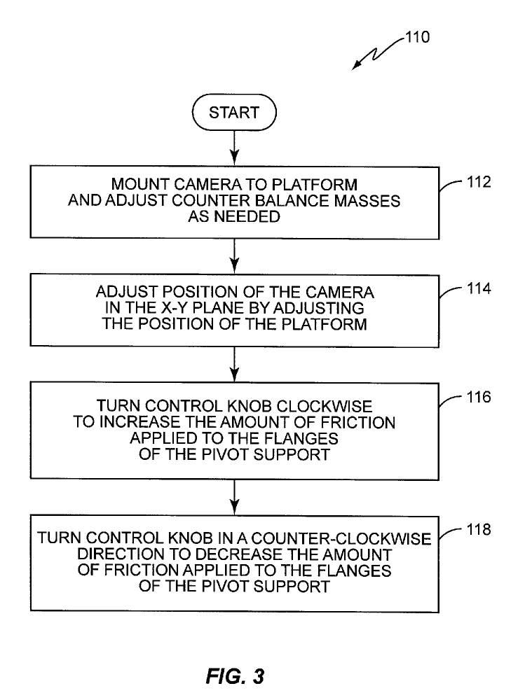

FIG. 3 is a flow chart that illustrates one method 110 of using the friction control 90 to vary and control the amount of friction applied to the multi-axis pivot assembly 60 according to one embodiment of the present invention. Particularly, an operator would mount the camera 12 to the platform 22 and adjust the masses 36 on the counterbalance system 30 (box 112). The operator might also adjust the position of the camera 12 in the x-y plane using the user controls as needed or desired (box 114). The operator could then vary the amount of friction applied to the multi-axis pivot assembly 60 to reduce the undesirable effects of the rotational torque forces imparted on the stabilizer 10.

In one embodiment, for example, the operator would rotate the control knob 92 in a first direction (e.g., clockwise) to increase the friction applied to the multi-axis pivot assembly 60 (box 116). As the operator rotates the control knob 92, it causes the friction disk 96 to approach and contact the edges of the flanges 72, 74. For multi-axis pivot supports, such as the multi-axis pivot assembly 60, the friction disk 96 could contact the edge at least one flange 72, 74 on each of the roll and tilt axes. However, as described in more detail later, the friction disk 96 need only contact a single flange 72 or 74 on one of the roll and tilt axes.

As the operator continues to rotate the control knob 92 in the first direction, the loading force applied by the friction disk 96 to the flanges 72, 74 would increase, and thus, increase the effective rotational friction between the friction disk 96 and the flanges 72, 74 that it contacts. With the increasing friction, the multi-axis pivot assembly 60 would pivot less freely.

To reduce the amount of friction, the operator would rotate the control knob 92 in the opposite direction (e.g., counter-clockwise) (box 118). Such counter-rotation would reduce the loading force applied by the friction disk 96 on the flanges 72, 74, thereby reducing the effective rotational friction between the friction disk 96 and the flanges 72, 74. The reduced frictional contact would allow the pivot support 60 to pivot more freely.

It should be noted that, in some cases, increasing the frictional contact between the friction disk 96 and the flanges 72, 74 could produce z-axis (i.e., pan axis) torques during movement of the multi-axis pivot assembly 60. Such torque forces can, at times, cause the stabilizer 10 to move in a panning motion. However, although such movement is undesirable, this particular torque force will generally be small because it acts on a small radius, and therefore, will not significantly introduce anomalous panning motion during operation. Nevertheless, it is possible to virtually eliminate such z-axis torques by providing the operator with the ability to control the amount of friction applied to the multi-axis pivot assembly 60 on a per-axis basis.

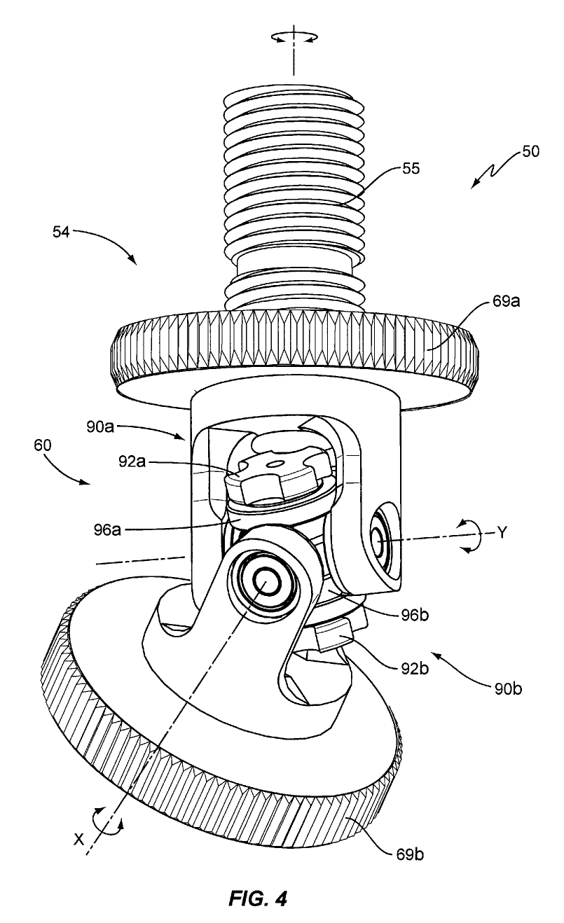

For example, FIG. 4 illustrates another embodiment in which the stabilizer 10 comprises two independent, user-adjustable friction controls 90a, 90b. Separate friction controls 90a, 90b may be positioned opposite each other on the multi-axis pivot assembly 60, and allow an operator to individually adjust the amount of friction applied to each of the roll and tilt axes. Each adjustable friction control 90a, 90b in FIG. 4 includes the same components previously discussed; however, the friction disk 96 of each adjustable friction control 90 is configured to contact only the flanges 72, 74 associated with one of the axes. Thus, an operator can increase or decrease the effective rotational friction between the x-axis flanges 72 and the first friction disk 96a by rotating a first control knob 92a, and the y-axis flanges 74 and the second friction disk 96b by rotating a second control knob 92b.

The previous embodiments illustrate “on-axis” frictional control in which one or more adjustable friction controls 90 are disposed substantially on-line with the z-axis. However, the present invention is not so limited. In other embodiments, one or more adjustable friction controls 90 may be offset from the z-axis. For example, a stabilizer 10 having a multi-axis pivot assembly with an offset support handle may include one or more adjustable friction controls 90 to apply the controlled friction. Such multi-axis systems are typically found on inertial stabilizers used with a body vest and articulated arm, as well as on some handheld inertial stabilizers.

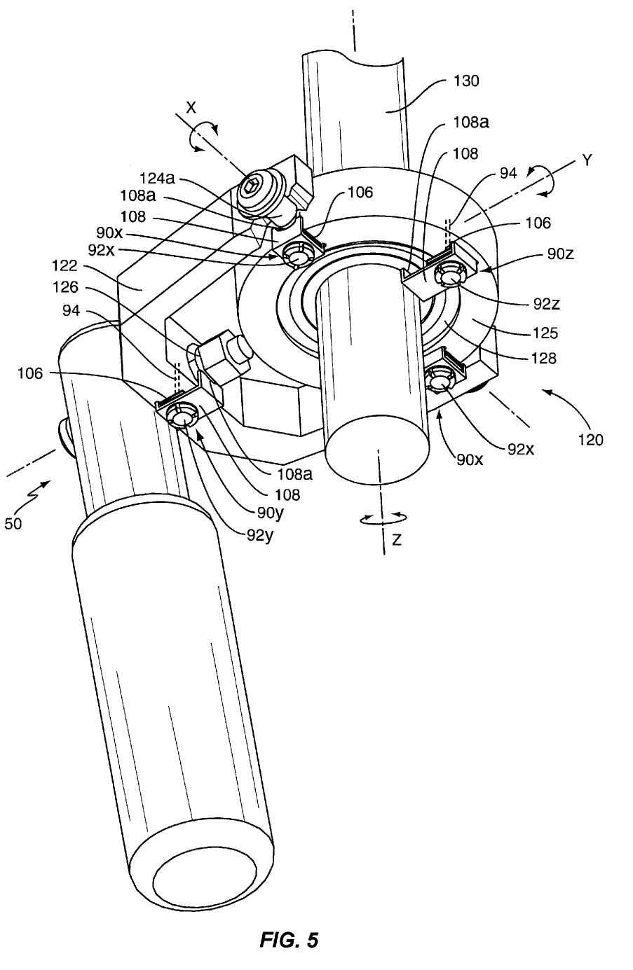

FIG. 5 illustrates one embodiment of the present invention as used with a three-axis pivot assembly 120 in which the point of rotation along the y-axis is offset from the z-axis. As seen in FIG. 5, the three-axis pivot support 120 includes a U-shaped yoke 122, a pair of x-axis bearings 124a, 124b pivotably connecting a support ring 125 to the yoke 122, a y-axis bearing 126 pivotably connecting the yoke to the handle assembly 50, and a z-axis bearing 128 that receives a shaft 130. The shaft 130 connects the three-axis pivot assembly 120 to the stage assembly 20 of stabilizer 10. A plurality of adjustable friction controls 90 are used to control the amount of force applied to the bearings 124, 126, and 128. With this embodiment, an operator can adjust the amount of force applied by one frictional control 90 independently from the other adjustable friction controls 90. This allows an operator to separately control the amount of friction applied to each bearing 124, 126, and 128.

Each of the x, y, and z-axis bearings 124, 126, 128 are low-friction bearings, for example, that allow movement or rotation about the x, y, and z-axes, respectively. Further, each of the bearings 124, 126, 128 permits rotation about their respective x (roll), y (tilt), and z (pan) axes, respectively, responsive to user motion to isolate a camera from the undesirable effects of that user motion. As seen in FIG. 5, the x-axis bearings 124 pivotably connect the support ring 125 to opposing ends of the yoke 122 such that the support ring 125 pivots about the x-axis. The y-axis bearing 126 pivotably connects the base of the yoke 122 to one end of handle assembly 50 such that the yoke 122 pivots about the y-axis. The z-axis bearing 128, which comprises a ring disposed concentrically within the support ring 125, receives and is fixedly attached to the shaft 130. The z-axis bearing 128 and the shaft 130 rotate together about the z-axis within the support ring 125, thereby providing z-axis rotation or panning movement.

In this embodiment of the present invention, each of the plurality of adjustable friction controls 90 comprises a respective control knob 92, one or more biasing members 106, such as a leaf spring, for example, and a clamp 108 having a contact edge 108a. Each adjustable friction control 90x, 90y, and 90z operates independently to increase and decrease the amount of friction applied to its respective bearing 124a, 124b, 126, and 128. As seen in FIG. 5, a pair of adjustable friction controls 90x are located on the x-axis bearings 124a, 124b to separately control the amount of force, and thus, the amount of friction, applied to those bearings. One z-axis adjustable friction control 90z is located on the z-axis bearing 128 to control the amount of force that is applied to the z-axis bearing, and one y-axis adjustable friction control 90y is located on the yoke 122 at the y-axis bearing 126 to control the amount of force that is applied to the z-axis bearing. Each control knob 92x, 92y, 92z is connected to a corresponding center pin 94. The center pins 94 for both the x-axis and z-axis adjustable friction controls 90x, 90z threadingly extend into the support ring 125 that pivots about the x-axis, while the center pin 94 for the y-axis adjustable friction control 90y threadingly extends into the yoke 122.

In operation, the operator turns selected control knobs 92 clockwise and counter-clockwise to control the amount of friction applied to the respective bearings. For example, as the operator rotates a control knob 92 in a first direction (e.g., clockwise), the control knob 92 presses on its associated clamp 108, which is suitably restrained from rotating, forcing its contact edge 108a into frictional engagement with an outer surface of its respective bearing 124a, 124b, 126, 128. The biasing member 106 is compressed with the rotating control knob 92. As the operator continues to rotate the control knob 92 in the first direction, the clamp edge 108a contacts and presses on its respective bearing 124a, 124b, 126, 128 with an increasing amount of force. This increasing force applies an increasingly greater amount of friction to the bearings 124a, 124b, 126, 128, which increases the resistance to the rotational movement of the bearing. To decrease the amount of friction, the operator rotates the selected control knob 92 in the opposite direction (e.g., counter-clockwise). The biasing member 106 de-compresses thereby moving the contact edge 108a of the clamp 108 away from the surface of its respective bearing 124a, 124b, 126, 128. This decreases the amount of force with which the contact edge 108a presses on the bearing surface, thereby allowing the bearings to rotate more freely. It should be noted that providing separate friction adjustments for the bearings 124a and 124b allows the operator to roughly match the friction contribution of each bearing to minimize or eliminate any z-axis torque that might result from unequal friction acting on the bearings 124a and 124b during x-axis rotation.

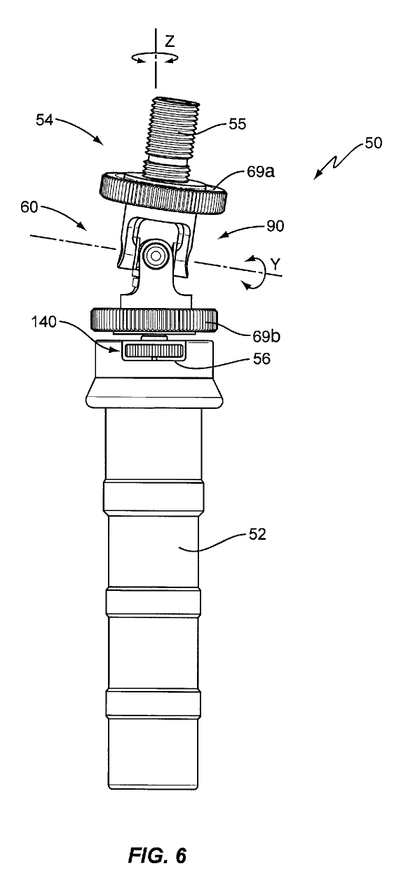

FIG. 6 illustrates another embodiment of the present invention in which the handle assembly 50 comprises multiple adjustable friction controls to allow the operator to control friction in each of the x, y, and z-axes. Particularly, a first adjustable friction control 90 is disposed with the multi-axis pivot assembly 60, and operates as previously described. A second adjustable friction control 140, however, is disposed within the interior of the handle grip 52. The second adjustable friction control 140 operates as a pan reduction control, or a Vernier control, to allow an operator to better control the panning motion of the stabilizer 10 about the z-axis. The adjustable friction control 140 also allows the operator to control the amount of friction that is applied on the z-axis, thereby helping to isolate the stabilizer 10 from unwanted z-axis torque. The adjustable friction control 140 is disposed so that the operator can easily access the control 140 through a cutout 56 in the handle grip 52 using only a thumb, for example.

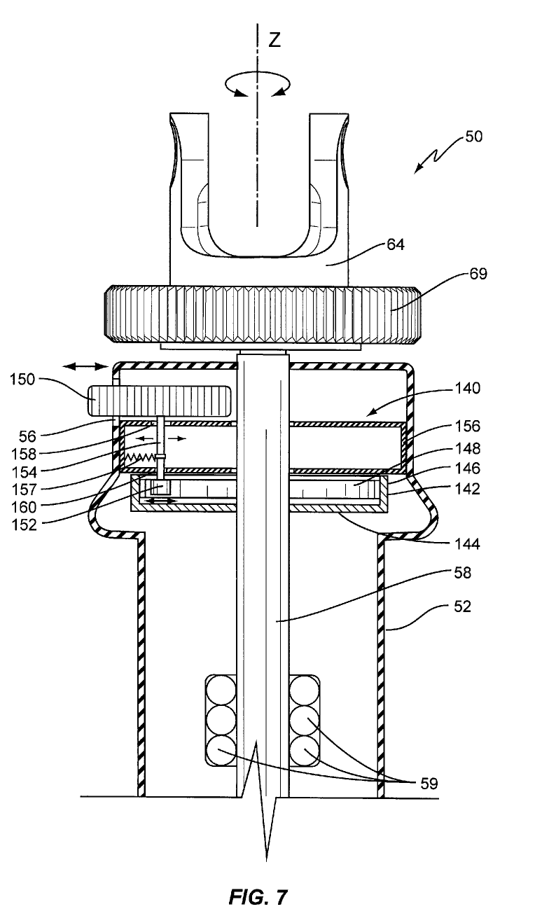

FIG. 7 illustrates the adjustable friction control 140, and the mechanism that allows the stabilizer 10 to rotate about the z-axis, in more detail. As seen in FIG. 7, a shaft 58 extends longitudinally through the interior of the handle grip 52 and is fixedly attached to the lower pan control ring 69b. A plurality of low-friction z-axis bearings 59 are disposed around the shaft 58 within the interior of the handle grip 52. The operator may turn or rotate the lower pan control ring 69b in either the clockwise or counter-clockwise directions to rotate the stabilizer 10 freely about the z-axis without any substantial effect on the roll or tilt axes x and y. As the shaft rotates about the z-axis, so does the yoke 64 and stabilizer 10.

The adjustable friction control 140 within the handle assembly 50 comprises a pan control wheel 142 and a thumb wheel 150. The pan control wheel 142 is formed as a disk having a base 144 and a surrounding sidewall 146. The base 144 fixedly attaches to the rotating shaft 58. Thus, when shaft 58 rotates about the z-axis, so, too, does the pan control wheel 142. The sidewall 146 forms the outer circumferential wall of the pan control wheel 142. A continuous elastic O-ring 148, for example, may be placed into a groove formed on an interior surface of the sidewall 146. The O-ring 148 extends around the interior of the sidewall 146.

The thumb wheel 150 extends at least partially out of the cutout 56 in handle grip 52 so that the operator can easily access the control. The thumb wheel 150 is connected to a drive wheel 152 via a shaft 154. The drive wheel 152 is normally biased inwardly towards the shaft 58 and away from the O-ring 148 by a biasing member, such as spring 157. The thumb wheel 150, the shaft 154, and the drive wheel 152 all rotate together whenever the operator turns or rotates the thumb wheel 150. A support member 156 is fixedly attached to the interior sidewall of the handle grip 52, and is disposed between the bottom surface of the thumb wheel 150 and the top surface of the pan control wheel 142. The support member 156 functions to support the thumb wheel 150 above the pan control disk 142. Additionally, the support member 156 functions to allow the shaft 154 to pivot or move back and forth responsive to pressure exerted by the operator on the thumb wheel 150.

More particularly, the support member 156, in this embodiment, comprises a unitary, substantially hollow ring. A first opening 158 is formed as an elongated hole through the upper part of the support member 156 closest to the thumb wheel 150. In one embodiment of the present invention, the first opening 158 provides a free path for the shaft 154 to move back-and-forth towards and away from the shaft 58 responsive to the operator pushing the thumb wheel 150. A second opening 160 is formed as a hole on the lower part of the of the support member 156, and positioned opposite the elongated opening 158 formed on the upper part of the support member 156. The second opening 160 is smaller than the first opening 158, but is sized so that it will also allow some back-and-forth movement of the shaft 154 responsive to operator pressure on the thumb wheel 150. The shaft 154 extends through both openings 158, 160, which are preferably wide enough to allow the shaft 154 to rotate freely. The spring 157 clips onto the shaft 154 such that it allows the shaft 154 to rotate freely, but also biases the shaft 154 normally to “pivot” the thumb wheel 150 away from the shaft 58, and the drive wheel 152 towards the shaft 58.

As previously stated, the operator may use the adjustable friction control 140 to increase or decrease the amount of friction to control the free rotation of the stabilizer in the z-axis. For example, the operator can prevent rotation about the z-axis by increasing friction. Using the thumb of the same hand that is holding the handle grip 52, for example, the operator can simply push the thumb wheel 150 inwardly towards shaft 58. The openings 158, 160 allow the shaft 154 to move with the thumb wheel 150. Further, pushing the thumb wheel 150 inwardly towards the z-axis shaft 58 causes the drive wheel 152 to pivot into contact with the elastic O-ring 148. Because the O-ring 148 is formed from an elastic material, such as rubber, for example, the friction between the drive wheel 152 and the O-ring 148 effectively prevents the pan control wheel 142 from rotating, thereby preventing the rotation of the shaft 58 due to z-axis torque. To allow free rotation in the z-axis, the operator need only to release the pressure exerted on the thumb wheel 150. The normal bias of spring 157 then causes the thumb wheel 150 to pivot away from the shaft 58, and the drive wheel 152 to pivot towards the shaft 58 and out of contact with the O-ring 148.

In addition to preventing z-axis rotation, the operator can also use the adjustable friction control 140 for fine control of the panning motion of stabilizer 10. Specifically, the operator pushes on the thumb wheel 150 to pivot the drive wheel 152 into contact with the O-ring 148, as stated above. Once in contact, the operator may turn or rotate the thumb wheel 150 in the clockwise or counter-clockwise directions. The rotating thumb wheel 150 causes the drive wheel 152 to rotate, which in turn, rotates the pan control wheel 142 and shaft 58 via O-ring 148.

In this embodiment, the direction of z-axis rotation of the stabilizer 10 is the same direction as the thumb wheel 150 rotation. Therefore, with this embodiment, rotating the thumb wheel 150 in the clockwise direction will cause the stabilizer 10 to also rotate in the clockwise direction. Rotating the thumb wheel 150 in the counter-clockwise direction will cause the stabilizer to also rotate in the counter-clockwise direction.

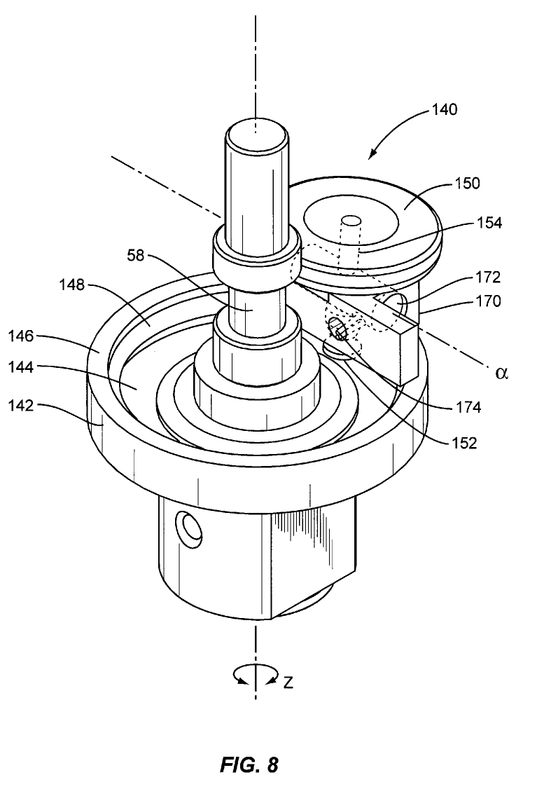

FIG. 8 illustrates another embodiment of the adjustable friction control 140. In this embodiment, the interior surface of the sidewall 146 of the pan control wheel 142 is notched or grooved, for example, to retain the O-ring 148. The thumb wheel 150 is connected to the drive wheel 152 via shaft 154. A support bracket 170 is mounted to the interior sidewall of handle grip 52, and is disposed between the underside of thumb wheel 150 and the pan control ring 142. The support bracket 170 houses a cylindrical member 172 that is free to rotate within the support bracket 170 about its longitudinal axis α. The cylindrical member 172 includes appropriately sized openings positioned to allow the shaft 154 to extend through the cylindrical member 172 transversally to the longitudinal axis α. The openings also allow the shaft 154 to rotate freely with the thumb wheel 150. A biasing member, such as hairpin spring 174, also extends transversally through the cylindrical member 172, and is retained in a notch or channel formed in the support bracket 170. The spring 174 is selected to exert a pressure between the support bracket 170 and the cylindrical member 172 to bias the drive wheel 152 away from the O-ring 148

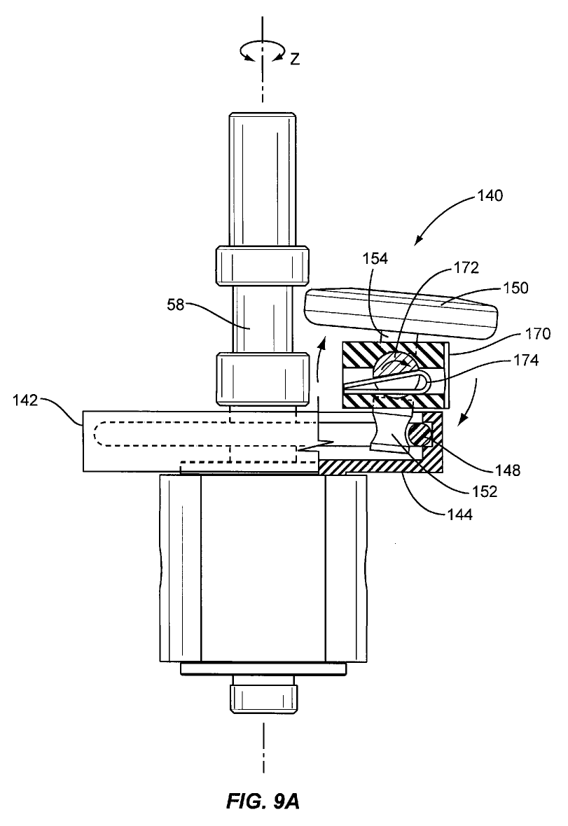

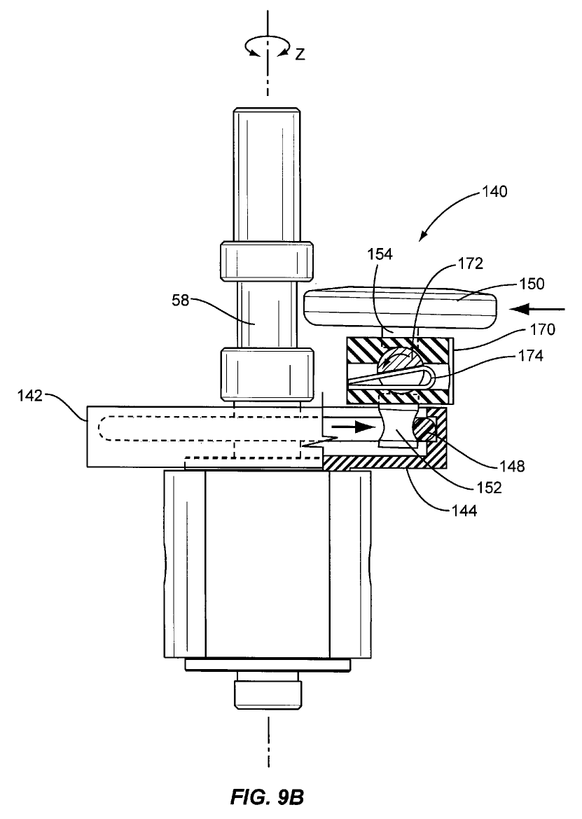

FIGS. 9A-9B illustrate the operation of the adjustable friction control according to this embodiment. As seen in FIG. 9A, the hairpin spring 174 normally biases the cylindrical member 172 to rotate about it's longitudinal axis a in the direction of the arrow. The rotation of the cylindrical member 174 pivots the shaft 154 extending through it such that the thumb wheel 150 pivots outwardly away from the z-axis shaft 58, and the drive wheel 152 pivots out of contact with the O-ring 148. In this position, the inertial stabilizer 10 is permitted to rotate freely about the z-axis.

As seen in FIG. 9B, when the operator presses the thumb wheel 150 inwardly, the cylindrical member 172 rotates about in the opposite direction about its longitudinal axis α. This rotation pivots the shaft 154 thereby causing the drive wheel 152 to pivot into contact with the O-ring 148 on the pan control wheel 142. In this position, the operator can substantially prevent rotation of the stabilizer 10 about the z-axis by simply maintaining the pressure on the thumb wheel 150. Such pressure is adequate with which to prevent the undesirable motion of the stabilizer 10 due to z-axis torque. However, the operator may also rotate the stabilizer 10 about the z-axis (i.e., pan the stabilizer 10) in a controlled manner by simply turning the thumb wheel 150. When the operator releases the thumb wheel 150, the hairpin spring 174 biases the cylindrical member 172 to pivot the drive wheel 152 away from contact with the O-ring.

The present invention may, of course, be carried out in other ways than those specifically set forth herein without departing from essential characteristics of the invention. Therefore, the embodiments described in this specification are to be considered in all respects as illustrative and not restrictive, and all changes coming within the meaning and equivalency range of the appended claims are intended to be embraced therein.

What is claimed is:

1. An inertial stabilizer for a camera, the stabilizer comprising:
a support assembly comprising a stage that supports a camera and a counterbalance; and
a handle assembly connected to the support assembly and comprising:
a handle grip;
a multi-axis joint connecting the handle grip to the support assembly such that the handle grip and the support assembly move relative to each other in at least two axes of rotation; and
an adjustable friction control to control an amount of friction on one or more axes of rotation.

2. The inertial stabilizer of claim 1 wherein the adjustable friction control is adjustable by a user to increase and decrease the amount of friction that is applied to the multi-axis joint on one or more of the axes of rotation.

3. The inertial stabilizer of claim 2 wherein the adjustable friction control applies a user-defined amount of force to the multi-axis joint on a first axis of rotation to increase and decrease the amount of friction applied to the first axis.

4. The inertial stabilizer of claim 3 wherein the adjustable friction control applies the user-defined amount of force to the multi-axis joint on a second axis of rotation to increase and decrease the amount of friction applied to the second axis.

5. The inertial stabilizer of claim 1 wherein the adjustable friction control comprises a first adjustable friction control configured to increase and decrease the amount of friction on at least one of the axes of rotation of the multi-axis joint, and further comprising a second adjustable friction control configured to control an amount of friction on a third axis of rotation.

6. The inertial stabilizer of claim 5 wherein the second adjustable friction control is adjustable by a user to substantially control the rotation of the stabilizer about the third axis.

7. The inertial stabilizer of claim 5 wherein the second adjustable friction control is adjustable by a user to substantially prevent the rotation of the stabilizer about the third axis.

8. The inertial stabilizer of claim 1 wherein the adjustable user control increases and decreases the amount of friction applied to the one or more axes of rotation responsive to user input to substantially control the rotation of the inertial stabilizer about the one or more axes of rotation.

9. The inertial stabilizer of claim 1 further comprising a plurality of adjustable friction controls, each configured to increase and decrease an amount of friction that is applied to a corresponding axis of rotation.

10. An inertial stabilizer for a camera, the stabilizer comprising:
a handle assembly configured to connect to a support assembly that supports a camera, the handle assembly comprising:
a handle grip;
a multi-axis joint connecting the handle grip to the support assembly such that the handle grip is substantially co-axial with a pan axis of rotation of the inertial stabilizer, and such that the handle grip and the support assembly move relative to each other about a roll axis of rotation and a tilt axis of rotation of the inertial stabilizer; and
an adjustable friction control to control an amount of friction applied on one or more of the axes of rotation.

11. The inertial stabilizer of claim 10 wherein multi-axis joint comprises first and second pivot bearings that allow the handle grip to pivot relative to the support assembly about the roll and tilt axes of rotation, respectively, and wherein the user adjustable control is connected to the multi-axis joint.

12. The inertial stabilizer of claim 11 and wherein the user adjustable control comprises a friction member configured to contact and apply a user-defined amount of force to one or both of the pivot bearings to increase and decrease the amount of friction applied to the contacted pivot bearings.

13. The inertial stabilizer of claim 10 wherein the adjustable friction control is disposed at least partially within the handle grip, and is movable by the user between a first position in which the inertial stabilizer is permitted to rotate freely about the pan axis, and a second position in which the user controls the rotation of the inertial stabilizer about the pan axis.

14. The inertial stabilizer of claim 13 further comprising a biasing member disposed proximate the adjustable friction control to bias the adjustable friction control towards the first position.

15. The inertial stabilizer of claim 13 wherein in the second position, the inertial stabilizer is substantially prevented from rotating about the pan axis.

16. The inertial stabilizer of claim 10 wherein the adjustable friction control comprises a first user adjustable friction control connected to the multi-axis joint, and is configured to increase and decrease the amount of friction applied to one of a roll axis and a tilt axis of rotation.

17. The inertial stabilizer of claim 16 wherein the first user adjustable friction control is further configured to increase and decrease the amount of friction applied the other of the roll and tilt axes of rotation.

18. The inertial stabilizer of claim 16 further comprising a second user adjustable friction control disposed within the handle grip, and configured to increase and decrease the amount of friction applied to the pan axis of rotation.

19. An inertial stabilizer for a camera, the stabilizer comprising:
a handle assembly configured to connect to a support assembly that supports a camera, the handle assembly comprising:
a handle grip;
a multi-axis joint connecting the handle grip to the support assembly such that the handle grip is substantially offset from a pan axis of rotation of the inertial stabilizer, and such that the handle grip and the support assembly move relative to each other at least about a roll axis of rotation and a tilt axis of rotation of the inertial stabilizer; and
a plurality of adjustable friction controls to control an amount of friction applied on one or more of the axes of rotation.

20. The inertial stabilizer of claim 19 wherein each adjustable friction control comprises a user adjustable control configured to independently increase and decrease the amount of friction applied on a respective axis of rotation.

21. The inertial stabilizer of claim 19 wherein the multi-axis joint comprises a plurality of pivot bearings, each bearing configured to permit the handle grip and the support assembly to pivot relative to one another about a respective one of the roll, tilt, and pan axes.

22. The inertial stabilizer of claim 21 wherein each adjustable friction control comprises a friction member configured to contact a corresponding pivot bearing with a user-defined amount of force to control an amount of friction applied to the corresponding pivot mechanism.

23. The inertial stabilizer of claim 22 wherein each adjustable friction control further comprises a control to allow the user to vary the amount of force with which the friction member contacts its corresponding pivot bearing.

24. The inertial stabilizer of claim 20 wherein the plurality of adjustable friction controls comprises:
a first user adjustable friction control configured to vary the amount of friction applied to the roll axis of the multi-axis control;
a second user adjustable friction control configured to vary the amount of friction applied to the tilt axis of the multi-axis control; and
a third user adjustable friction control configured to vary the amount of friction applied to the pan axis of the multi-axis control.
